(19) United States
(12) Patent Application Publication
(10) Pub. No.: US 2007/0162402 A1
(43) Pub. Date: Jul. 12, 2007

(54) SECURING OF ELECTRONIC TRANSACTIONS

(76) Inventor: Philippe Hoij, Malmö (SE)

Correspondence Address: GAUTHIER & CONNORS, LLP, 225 FRANKLIN STREET, SUITE 2300, BOSTON, MA, 02110, US

(21) Appl. No.: 11/564,434

(22) Filed: Nov. 29, 2006

Related U.S. Application Data
(63) Continuation of application No. PCT/SE05/00851, filed on Jun. 2, 2005.

(30) Foreign Application Priority Data
Jun. 2, 2004 (SE) 0401411-4

(51) Int. Cl. G06Q 99/00

(52) U.S. Cl. 705/75

(57) ABSTRACT

A method in an approval service and a corresponding method in a user identity unit for securing of an electronic transaction. The method comprises a number of steps that begins with receiving of a request of approving a business transaction associated with at least one user identity and one business service, after which a check of the authority of the user identity to use the business service is performed. An exchange with the user identity is then performed of an encrypted and signed verification document that comprises at least information about the business transaction. The business transaction is then approved depending on the contents of the verification document.

### TECHNICAL AREA

The present invention relates to methods for securing of transactions in digital communications systems, in particularly authentication, authorization and accounting.

### BACKGROUND

The concept of electronic transactions in digital communication systems normally refers to ordinary functions and consequences of functions that are performed in the collaboration between a user and one or several interconnected computers at suppliers of services, or solely between interconnected computers. Typical examples include bank services, reservation services, electronic commercial centers, so-called communities, and on-logging to computers in connection with services, such as e-post, file sharing etc.

Even if the user concept normally has a “human” connection it shall be emphasized that the concept also includes “non-human” entities, i.e. machines in the form of computers. Hence, the concept of a user identity will be used below and it shall be interpreted to be exchangeable with the concept of a user.

Characterizing for the majority of these services is that they comprise handling of information that is valuable for the user. Examples of this sort of information include assets on a bank account or other sensitive information. Moreover, it is usually of outmost importance that this sort of information is managed in a way that makes it impossible, or at least very difficult, for unauthorized persons to access the information.

A number of different security systems and methods have been created in prior art to comply with the need to make it as difficult as possible for unauthorized persons to access user information. Concepts such as authentication, authorization and accounting are well known and well documented in prior art.

In brief words, authentication means that the identity of a user of a transaction system is secured for other users of the system, or for the system itself. Authorization means that the authority of a preferably authorized user to perform transactions within the system or with other users of the system by means of the system is secured. Accounting means that information regarding the measures and transactions of a user within the system are registered and stored so that an authorized user identity can read and interpret the information at any point of time.

The solutions for authentication available today uses a so-called “in-band” authentication, which means that authentication data is transmitted via the same route as data is transmitted and received later on during the transaction process. This procedure implies that identification of the user is performed by e.g. a user name and a password, a single-use password or similar. Regardless if encryption of data and verification of the user is performed via a certificate, the system can never know if it really is the right person that is sitting behind the terminal that is used, even though the user is seemingly identified. Further, in most cases the real user will never find out if someone other than himself has logged on by means of their identification information, so-called accounting. Further, this means that it is practically impossible for a user to know if his logon information has been disseminated or that a single-use password is used by others than the user himself (e.g. if someone has copied the user's list of single-use passwords). Besides, there is a fundamental problem regarding passwords, they are often easy to guess or crack via so-called “brute-force”/“dictionary”—attacks.

Basically the identification and approval systems of today are insecure because the logging of erroneous logons is preformed by the system owner and not by the service account holder. Even if known systems for example use single-use passwords an authorized user has no possibility to prevent an unauthorized user from misusing a password that he has acquired.

Examples of the use of “in-band” handling of an authentication can be found i.a. in U.S. Pat. No. 6,285,991 and in the product “.NET Passport” from Microsoft Corporation, and in the great majority of network services wherein usernames and passwords are used.

### SUMMARY OF THE INVENTION

Consequently, a purpose of the present invention is to resolve the problems that are related to the authentication, authorization and accounting in connection with electronic transactions in prior art.

This purpose is achieved according to a first aspect by a method in an approval service for securing of an electronic transaction. The process comprises a number of steps that are initiated by receiving a request to approve a business transaction associated with at least one user identity and one business service, after which the authorization of the user identity to use the business service is controlled. Exchange with the user identity is then preformed by an encrypted and signed verification document, which at least comprises information about the business transaction. The business transaction is then approved depending on the contents of the verification document.

In a preferred embodiment the control of the user's authorization comprises receiving of identification information regarding the user identity, and the exchange of the verification document comprises fetching of a public certificate that is associated with the user identity. The verification document is created, is encrypted by means of the public certificate of the user identity and is signed by means of the private key of the approval service. The verification document is then transmitted to the user identity.

When the verification document has been transmitted to the user identity a processing of the verification document is performed at the user identity, as will be discussed below in connection with a second aspect of the invention.

The verification document is then received from the user identity, and the public certificate of the user identity is fetched. A verification of the signature of the user identity is performed, after which the verification document is decrypted by means of the private key of the approval service. Interpretation of the content in the verification document is then performed to, depending upon the content. approve the business transaction.

The identification information regarding the user is preferably available in a list of identification information, and the control of the authorization of the user identity is preferably performed so that it comprises communication between the approval service and a first catalogue service that comprises the list of identification information. The fetch of certificates preferably comprises communication between the approval service and a second catalogue service that comprises the list of certificates.

In an embodiment the approval service is a part of the business service.

From a second aspect the purpose of the present invention is achieved by a method in a user identity unit for securing of an electronic transaction. The method comprises an exchange with an approval service of an encrypted and signed verification document, which at least contains information about the business transaction. Authorization data is given, depending on the content of the verification document, the meaning of which is intended to enable the approval service to approve the business transaction.

In other words, by using “out-of-band” authentication of user identities, in which only the identifier (e.g. the user name) is passed via the medium of the business system, the advantage of high security can be achieved. This kind of security implies that the user identity approves a transaction by performing both authentication and authorization via a parallel or auxiliary channel, i.e. via the approval service. The consequence of this is that a much higher security can be provided, both for approving transactions and for approving access to a defined business service. By using an asymmetric encryption, with public certificates and private keys wherein encryption and signing of information can be achieved, a secure and parallel or auxiliary channel is obtained that cannot be read from outside. Hereby, the holder of the business service, for example, can be sure that the user of the service is the one who owns the account/authorization right, since the transaction-approval-question is transmitted to the authorized user. Authorized user identities are also arranged in the system that approves the logon of a user identity, so that the system knows who is authorized to use the system. However, the user identity itself approves if access to the system shall be given.

The present invention is advantageously used within a plurality of different application areas, comprising electronic billing, logon to systems, voice recognition, micro payment systems, withdrawal of money and other payment approvals, such as approval of credit card payments in a store. The invention is also applicable in different kinds of systems requiring cooperation between different users to approve transactions, for example logons and even more sturdy transactions such as retrieval of hardware, passage through doors etc.

### BRIEF DESCRIPTION OF THE DRAWINGS

FIG. 1 shows schematically a digital communication system wherein the present invention is implemented.

FIGS. 2a and 2b is a flow chart which illustrates a method in an approval service according to the present invention.

FIG. 3 is a flowchart which illustrates a method in a client according to the present invention.

### PREFERRED EMBODIMENTS

First a brief explanation of asymmetric encryption is given, followed by a description of a system in which the present invention is advantageously implemented. Then a detailed description follows of a method in accordance with the present invention. It shall be noted that the user concept shall be regarded as exchangeable with the concept of a user identity, i.e. a user is only an example, in a human shape, of an identity that functions in accordance with the invention.

Asymmetric encryption is based on public certificates and private keys, which are associated with each other in pairs. The public certificate is available to everyone and shall be available to the public, e.g. via a public catalogue service. The important thing about the public certificate is that the information in the certificate comes from a secure source. The information in the private key shall be kept secret for all times and must only be used by the one who shall sign or decrypt information that shall be transmitted or received.

Data that is encrypted by means of a public certificate can only be decrypted by the one who owns the private key that is associated with the public certificate.

Data that is signed by a private key can be checked by means of the public certificate that is associated with the private key. The signature means that the information that was originally signed must be the same information up to the point in time when the signature is checked against the public certificate, and that the person who signed the information is known when the signature and the public certificate matches each other.

Even if it is preferred that an asymmetric encryption by means of digital certificate is used when the invention is implemented, a person skilled in the art understands that the invention can be implemented by means of other kinds of cipher solutions.

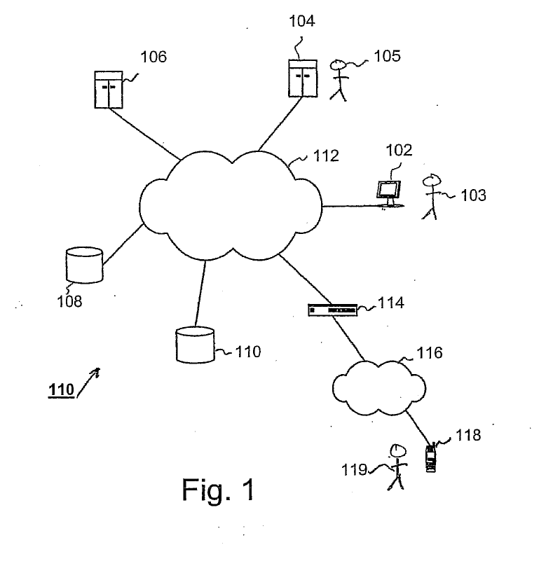

FIG. 1 shows a system 100 comprising a number of communicating parties connected to a communication network 112. A first user unit 102, e.g. a personal computer, is arranged to provide a user 103 with access to a business service 104, which may be a bank, a shop or similar. A second user 105 has access to the business service 104 by a more direct personal contact, e.g. by being present at a location, e.g. at a bank office or a shop, having personnel that can control the business service 104. A third user 119 has access to the business service 104 via a mobile station 118, e.g. a mobile phone, that is arranged to communicate by means of a mobile network 116, via a network bridge 114, to the communication network 112 to which the business service 104 is connected.

An alternative way of using a mobile terminal may be that a user, e.g. the first user 103, uses a mobile phone for approving a logon to the business service. In other words, the user utilizes a user terminal in the shape of a personal computer to request access to and to communicate with a business service, after which the user uses the mobile phone for approving a transaction.

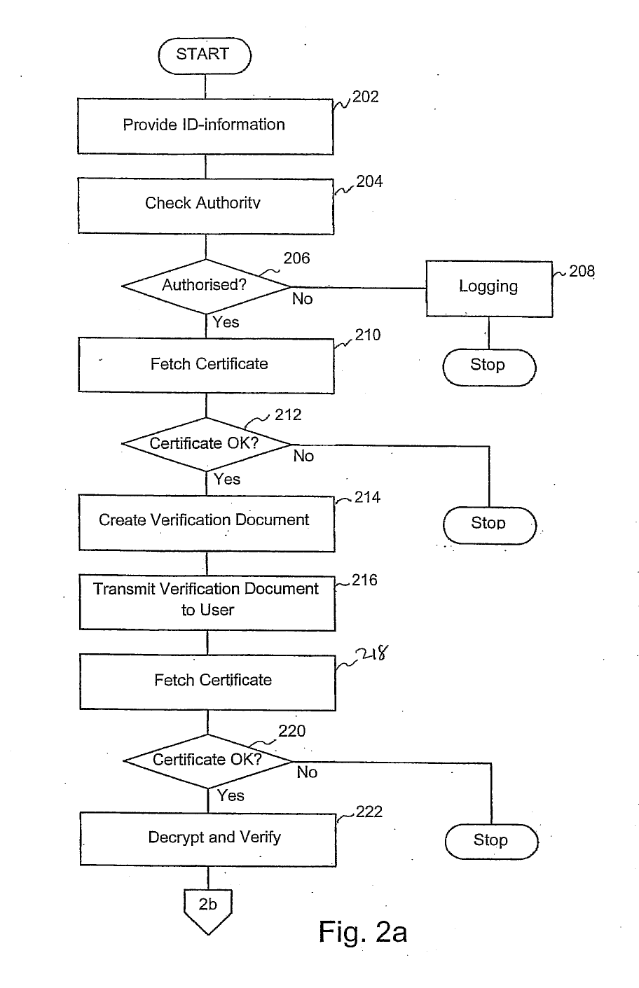

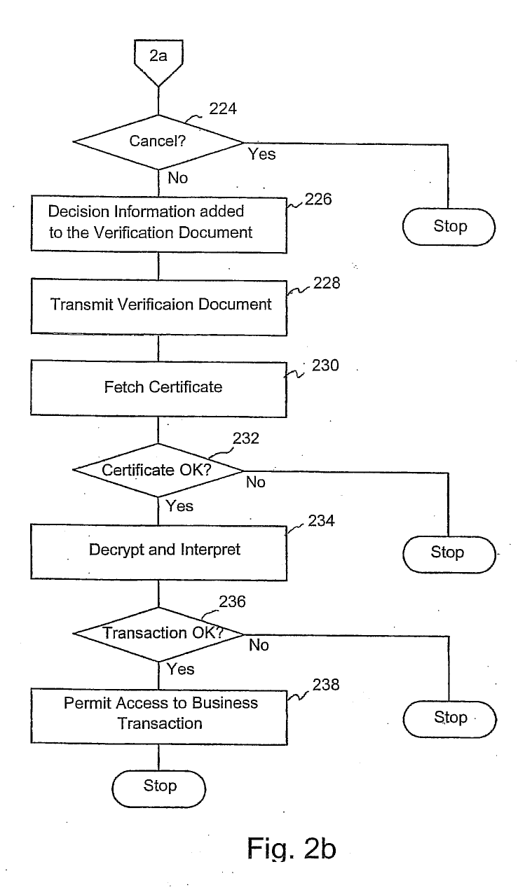

The business service 104 is preferably implemented in the form of software components in a computer, and it has the task of receiving a request from a user to perform a business transaction, and it is equipped with the functionality for execute or at least control the execution of this business transaction. The business service 104 is further equipped with the functionality for exchanging information with the approval service 106, as will be described more closely with reference to the flowchart in FIG. 2.

The approval service 106 is connected to the communication network 112. The approval service 106, which is also preferably implemented by means of software in a computer, has the task of handling the information and the transmission of information between i.a. users and the business service, as will be described more closely below with reference to the flowchart in FIG. 2.

An alternative embodiment of the approval service implies that it performs a part of the business service.

A first catalogue service 108 and a second catalogue service 110, implemented in the form of software components in one or several computers, are also connected to the communication network 112. These catalogue services 108, 110 have the main function of providing data to users and the approval service 106. In its simplest embodiment the first catalogue service 108 comprises a list or a database with identification information regarding users that are authorized to use the business service. The second catalogue service 110 in its simplest embodiment comprises information in the form of a list of public certificates belonging to users and service providers. The use of these catalogue services will be described more closely with reference to the flowchart in FIG. 2.

A method in accordance with the present invention will now be described with reference to the flowchart in FIGS. 1, 2a and 2b. The situation is that a user, whoever of the first user 103, the second user 105 or the third user 119, intends to perform a business transaction in cooperation with the business service 104. In the case the user is the first user 102 the communication with the business service 104 takes place via interface, such as a homepage on the World Wide Web associated with the business service 104, by means of the user unit 102 that is preferably a personal computer or similar. In the case the user is the second user 105 the communication with the business service 104 takes place via a direct contact at premises of the business service, which e.g. is a bank office or a shop. In the case the user is the third user 119 the communication with the business service 104 takes place via the telephone 118, the mobile system 116 and the network bridge 114.

To avoid obscuring the present invention by unnecessary details no closer description will be given of the details how the communication takes place between the different units in the communication system 112. A person skilled in the art will choose suitable courses of action, in the form of choosing messenger service, communication protocols etc. in implementing the invention.

In an initial step 202 the business service 104 requests the user, which is in contact with the business service 104 and whishes to perform a business transaction, to identify himself. The user meets this request in that data in the form of identification information is provided by the user to the business service 104, which then is transmitted from the business service 104 to the approval service 106. Suitably, the identification information comprises at least a user identity, such as a name, a number combination and a sequence of signs. Suitably, the identification information also comprises a character string that describes the business transaction in question.

In a checking step 204 the approval service 106 is checking that the transmitted identification information correspond to a user that is authorized to use the business service 104, by matching the identification groups towards a catalogue of the identification information for authorized users, which preferably are available at the first catalogue service 108.

If the identification information is not approved or not present in the catalogue the transaction is interrupted in a decision step 206 and the approval service 106 will respond that the transmitted identification information can not use the service. A message regarding the occurred event can be transmitted in a logging step 208 to the owner of the user account, or the owner of e.g. the business service or the approval service.

In a fetching step 210 the approval service 106 is fetching the public certificate from the second catalogue service 110.

If the public certificate of the identification information does not exist, has expired or if it is canceled (withdrawn), or is otherwise unavailable, the transaction will be interrupted in a decision step 212. A logging can be performed here as well, as described above in connection with step 206 and 208.

A verification document will be created in a document creating step 214, which document comprises a time stamp, a unique character string and the identification information. Certainly, information identifying details regarding the transaction can also be included in the verification document. The verification document is encrypted by means of the public certificate of the user, such that only the user can decrypt it, and it is then signed with the private key of the approval service 106.

The verification document is then transmitted to the user in a transmission step 216. The transmission is performed by means of a suitably chosen messenger service, such as e-mail, a instant messenger service or some other messenger service that can transmit messages.

In a fetching step 218 the user fetches the public certificate of the approval service 106 from the second catalogue service 110.

If the public certificate of the identification service 106 does not exist, has expired or if it is canceled (withdrawn), or is otherwise unavailable, the transaction will be interrupted in a decision step 220.

In a decryption step 222 the user decrypts the verification document by means of his private key when the user has controlled, by means of the signature and the public certificate of the approval service 106, that the service is known and trusted by the user.

In a decision step 224 the user chooses to approve or deny access to the approval service 106, or to not send a reply, which will later be interpreted in the same way as the user has denied access to the service. Here, the user himself can choose to interrupt the transaction.

In a processing step 226 the user adds information about the approval or denial into the verification document, encrypts it with the public certificate of the approval service 106, and signs the document with his private key.

The verified document is then transmitted back in a transmitting step 228 to the approval service 106, as an authentication and authorization or as a denial, depending on the decision step 224.

In a fetching step 230 the approval service 106 is fetching the public certificate of the identification information from the second catalogue service 110.

If the public certificate does not exist, has expired or if it is canceled (withdrawn), or is otherwise unavailable, the transaction will be interrupted in a decision step 232.

In a processing step 234 the signature is verified with respect to the digital certificate that is associated to the identification information, after which the content is decrypted by means of the private key of the approval service 106 and authorization data is read from the document that is verified by the user.

The transaction will be interrupted in a decision step 236, if the verified document that is transmitted back to the approval service 106 comprises a denial.

If the verified document transmitted back to the approval service 106 comprises an approval, and consequently information that the user is authenticated and that the transaction is approved, access to the service will be granted in a permission step 238, which in a simple embodiment comprises transmission of a signal or message to the business service 104.

The user can encrypt his personal key, which should be kept secret, e.g. stored in the user's mobile phone, computer or similar by means of a password such that the private key demands authentication to be able to be used, which means that the key is also protected.

Authentication, when using a messenger service when transmitting information between the user and the approval service 106, is preferably performed by means of the certificates, but this is outside the scope of the present invention.

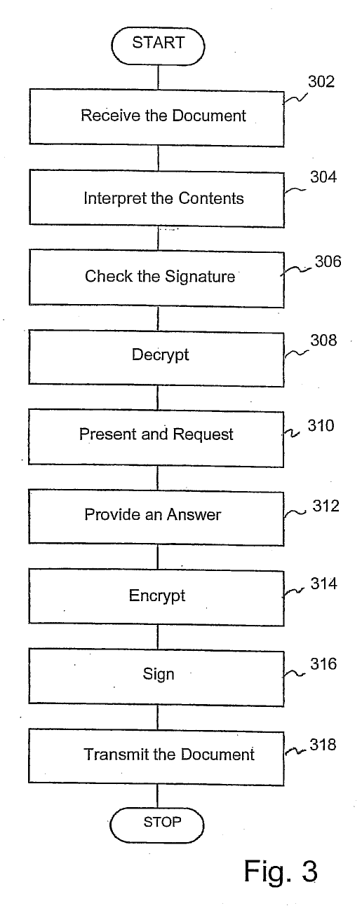

Below follows, with reference to FIGS. 1 and 3, a description of a method that is performed, e.g. in the computer or mobile communication unit of a user when he is communicating with the approval service in accordance with the method described in FIGS. 2a and 2b. The method that will be described can therefore be labeled as a client method that operates in cooperation with the other parts of the system and which has the task of presenting an authorization and authentication question to a user and transmitting back an answer to the question.

By “user” is meant e.g. a physic person, a legal person, another system or service, or another entity with the ability to make a decision based upon received information.

In a reception step 302 a message is received by a communication interface to which the client is connected, electronically or otherwise.

In an interpretation step 304 the information in the message is interpreted to a format that is local for the user's communication unit or the computer.

In a control step 306 it is controlled that the message is signed and that the signature is issued by the one that is expected to have transmitted the message. The control is performed by checking the signature against a public certificate or by recognition of the signature.

In a decryption step 308 the content of the message is decrypted by using the private digital key of the user. The content of the message is one or several of the following, and also optional extra information: message regarding the transaction/the on logging/the voting/the question of authorization, permitted/possible answers to the question, transaction-ID etc.

In a presentation step 310 a method for authorization of the user is presented, e.g. adapted to the message, which method comprises a request that the user answers to the presented authorization method.

In an answer step 312 the user is providing one of the answering alternatives by appending the answer in a new message, possibly together with the transaction-ID and/or other information.

In an encryption step 314 the message is encrypted by means of the identity-associated certificate of the receiver (of the original receiver) or by means of another cipher.

In a signing step 316 the encrypted message is signed by means of the private key of the user or by another cipher.

In a transmission step 318 the signed encrypted message is transmitted to the original transmitter as an answer to the authorization or authentication question that was made via an elective communication interface to which the user is connected.

It shall be noted that the user can encrypt his personal key, which is to be kept secret, e.g. stored in the user's mobile phone or computer or similar by means of a password such that the private key requires an authentication to be able to be used, which means that even the key is protected. Authentication for using the message service can e.g. be performed by means of the certificates. However, this is outside the scope of the invention.

1. A method in an approval service for securing of an electronic transaction, comprising:
receiving of a request of approving a business transaction associated with at least one user entity and one business service,
checking of the authority of the user identity to use the business service,
exchanging with the user identity of an encrypted and signed verification document that comprises at least information about the business transaction,
depending on the contents of the verification document, approval of the business transaction.

2. A method with according to claim 1, wherein the
checking of the authority of the user identity comprises the receiving of identification information regarding the user identity,
exchanging of the verification document comprises fetching of a public certificate associated with the user identity, creating of the verification document, encryption of the verification document by means of the public certificate of the user identity, signing of the verification document by means of the private key of the approval service, transmitting of the verification document to the user identity and receiving of the verification document from the user identity,
and wherein
after the reception of the verification document from the user identity, fetching of the public certificate of the user identity, verification of the signature of the user identity, decryption of the verification document by means of the private key of the user service, followed by an interpretation of the contents of the verification document.

3. A method according to claim 1, wherein the verification information regarding the user is available in a list of identification information.

4. A method according to claim 1, wherein the certificates are available in a list.

5. A method according to claim 3, wherein:
the control of the authority of the user identity comprises communication between the approval service and a first catalogue service that comprises the list of identification information, and wherein
the fetching of certificates comprises communication between the approval service and a second catalogue service that comprises the list of certificates.

6. A method according to claim 1, wherein the approval service is a part of the business service.

7. A computer program comprising instructions that enables a computer to perform a method according to claim 1.

8. A method in a user identity unit for securing of an electronic transaction, comprising:
exchanging with an approval service of an encrypted and signed verification document that comprises at least information about the business transaction,
depending on the contents of the verification document, provide authorization data, the meaning of which is intended to enable the approval service to approve the approval the business transaction.

9. A computer program comprising instructions that enables a computer to perform a method according to patent claim 8.
